(19) United States
(12) Patent Application Publication
(10) Pub. No.: US 2013/0118531 A1
(43) Pub. Date: May 16, 2013

(54) EMULSIONS CONTAINING POLYMERIC CATIONIC EMULSIFIERS, SUBSTANCE AND PROCESS

(71) Applicant: The Procter & Gamble Company, Cincinnati, OH (US)

(72) Inventors: Rainer Anton Dobrawa, Ludwigshafen (DE); Dieter Boeckh, Ludwigshafen (DE); Aaron Flores-Figueroa, Ludwigshafen (DE); Markus Brym, Ludwigshafen (DE); Rajan Keshav Panandiker, West Chester, OH (US); Julie Ann Menkhaus, Cleves, OH (US); Frank Hulskotter, Schwalbach am Taunus (DE)

(73) Assignee: THE PROCTER & GAMBLE COMPANY, Cincinnati, OH (US)

(21) Appl. No.: 13/671,785

(22) Filed: Nov. 8, 2012

Related U.S. Application Data
(60) Provisional application No. 61/558,668, filed on Nov. 11, 2011.

(51) Int. Cl. C11D 3/37; B08B 3/04

(52) U.S. Cl. CPC C11D 3/3765; B08B 3/04
USPC 134/26; 510/515; 510/417

(57) ABSTRACT

The present invention is directed to fabric and/or home care compositions comprising oils and a polymeric cationic emulsifier, the process to obtain said emulsions and the use of said emulsions in fabric and/or home care compositions and the use of said fabric and/or home care compositions. Such fabric and/or home care compositions provide excellent cleaning and/or treatment properties.

### FIELD OF THE INVENTION

The present invention is directed to compositions comprising stable emulsions comprising oils and a polymeric cationic emulsifier, the process to obtain said emulsions and the use of said emulsions.

### BACKGROUND OF THE INVENTION

Oils such as silicone oils, natural oils, polyolefines and in particular polyisobutene are useful ingredients in a lot of technical applications. It is, however, still difficult to obtain stable emulsions comprising such oil(s) and water. There is always a need to add either surfactants or huge amounts of additional polymer.

PCT/EP2011/057586, which has not yet been published, discloses an emulsion comprising (a) polyolefines such as polyisobutene, polymers Px which are copolymers of non ionic, anionic or pseudocationic monomers and water.

DE 195 05 100 A1 relates to the preparation of polymers which are the product of the polymerization of bisesters of alkyl-or alkenyl carboxylic acid derivatives and polyalcohols. These polymers are used as solubilisers, emulsifiers and cleaning compounds.

WO 2007/042454 A1 describes the use of terpolymers of (a) maleic anhydride, (b) isobutylene and (c) polyisobutylene for producing aqueous emulsions or dispersions of hydrophobic substances such as silicones.

WO 2007/014915 writes on aqueous dispersions comprising (A) a polymer such as polyisobutene and (B) an emulsifier obtained by the polymerization of isobutylene, maleic anhydride and polyethyleneglycol. This dispersion is used for the treatment of leather or as additive in construction chemicals.

EP 0 995 791 A1 discloses a polymer formed by copolymerizing two or more monomers A, B and C, wherein A is selected from one or more C3-C8 monoethylenically unsaturated carboxylic acid moieties, B can be a C3-C60 alkyl(meth)acrylate and C is an ethylenically unsaturated monomer which is copolymerizable with monomers A and B. According to the disclosure, the polymer is used in solid form or liquid form, as an aqueous or co-solvent based solution, to promote the release of oily soil from fabrics.

U.S. Pat. No. 2,923,701 writes on a composition comprising a linear copolymer which is the product of (1) a single quaternary ammonium compound such as dially dimethyl ammonium chloride and (2) an ethylenically unsaturated compound. This copolymer may yield a fiber-forming copolymer or can be used as textile treating agent.

Therefore it is one goal of the present invention to provide a composition comprising an emulsion containing oil(s) and water, which display a good stability and which are suitable for the use in chemical technical applications, car wash, cosmetics, plant protection, preparation and treatment of paper, textiles and leather, adhesives, dye and pigment formulations, coatings, pharmaceutical applications, construction, wood treatment.

This goal is surprisingly reached by the compositions comprising emulsions according to claims 1 to 11. The process of producing a stable emulsion, the use of such an emulsion according to claim 12 as well as the polymeric cationic emulsifier according to claims 7, 8, and 9 form additional aspects of the present invention.

### SUMMARY OF THE INVENTION

The present invention is directed to compositions comprising stable emulsions comprising oils and a polymeric cationic emulsifier, the process to obtain said emulsions and the use of said emulsions.

### DETAILED DESCRIPTION OF THE INVENTION

For the purpose of this invention the prefix (meth) written before a compound means the respective unsubstituted compound and/or the compound substituted by the methyl group. For instance, “(meth)acrylic acid” means acrylic acid and/or methacrylic acid, (meth)acrylate means acrylate and/or methacrylate, (meth)acrylamide means acrylamide and/or methacrylamide.

As used herein, the term “fabric and/or home care composition” means products for tretaing fabrics, hard surfaces and any other surfaces in the area of fabric and home care, including: laundry detergent products, fabric conditioners (including softeners), laundry and rinse additives and care products, hard surface cleaner products and/or treatment products, car care products, dishwashing products, air care products, and other cleaner products for consumer and institutional use.

As used herein, articles such as “a” and “an” when used in a claim, are understood to mean one or more of what is claimed or described.

As used herein, the terms “include”, “includes” and “including” are meant to be non-limiting.

As used herein, the term “solid” includes granular, powder, bar and tablet product forms.

As used herein, the term “fluid” includes liquid, gel, paste and gas product forms.

As used herein, the term “situs” includes fabrics, garments, and hard surfaces.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein. Thus the present invention is directed to a composition comprising an emulsion comprising
a) oil(s) in an amount of from 2 to 75 weight %,
b) polymeric cationic emulsifiers Pₓ in an amount of from 0.05 to 40 weight %, wherein Pₓ is the product of the polymerization of
   A) one or more cationic ethylenically unsaturated monomers (monomer A),
   B) one or more linear or branched alkyl(meth)acrylates (monomer B),
   C) from 0 to 30 weight % of one or more C₃-C₈ monoethylenically unsaturated carboxylic acids (monomer C),
c) surfactant(s) Sₓ in an amount of from 0 to 25 weight %,
d) additive(s) Aₓ in an amount of from 0 to 20 weight % and
e) water in an amount of from 10 to 97.95 weight %,
based on the total weight of the emulsion.

The emulsion can consist of components a), b) and e), in which case the amounts add up to 100 weight %,—such an emulsion forms a preferred embodiment of the present invention. The emulsion can also contain components a), b) and e) as well as additional components. Emulsions, which in addition to components a), b) and e) also contain components c) and/or d) form one preferred embodiment of the invention. The inventive emulsion may also contain other components.

With regard to the amounts, in which the respective compounds are present in the emulsion there exist preferred ranges. Thus a composition comprising an emulsion according to the invention, wherein the components of the emulsion independently of each other are present in amounts of:
a) oil(s) in an amount of from 5 to 50 weight %,
b) polymeric cationic emulsifiers Pₓ in an amount of from 0.5 to 30 weight %, wherein Pₓ is the product of the polymerization of
   A) one or more monomers A,
   B) one or more monomers B,
   C) from 0 to 30 weight % of one or more monomers C,
c) surfactant(s) Sₓ in an amount of from 0.1 to 20 weight %,
d) additive(s) Aₓ in an amount of from 0.1 to 15 weight % and
e) water in an amount of from 30 to 90 weight %,
   based on the total weight of the emulsion, forms a preferred embodiment of the present invention.

Even more preferred is a composition comprising an emulsion, wherein the components of the emulsion independently of each other are present in amounts of:
a) oil(s) in an amount of from 10 to 40 weight %,
b) polymeric cationic emulsifiers Pₓ in an amount of from 0.5 to 15 weight %, wherein Pₓ is the product of the polymerization of
   A) one or more monomers A,
   B) one or more monomers B,
   C) from 0 to 30 weight % of one or more monomers C,
c) surfactant(s) Sₓ in an amount of from 0.1 to 15 weight %,
d) additive(s) Aₓ in an amount of from 1 to 10 weight % and
e) water in an amount of from 40 to 85 weight %,
   based on the total weight of the emulsion.

And most preferred is a composition comprising an emulsion, wherein the components of the emulsion independently of each other are present in amounts of:
a) oil(s) in an amount of from 15 to 30 weight %,
b) polymeric cationic emulsifiers Pₓ in an amount of from 0.5 to 5 weight %, wherein Pₓ is the product of the polymerization of
   A) one or more monomers A,
   B) one or more monomers B,
   C) from 0 to 30 mass % of one or more monomers C,
c) surfactant(s) Sₓ in an amount of from 0.5 to 10 weight %,
d) additive(s) Aₓ in an amount of from 2 to 8 weight % ad
e) water in an amount of from 50 to 80 weight %,
   based on the total weight of the emulsion.

To maximize the content of oil(s), it is advantageous to reduce the amount of other components in the emulsion. Therefore, further preferred compositions are those which contain an emulsion, which comprises:
a) oil(s) in an amount of from 15 to 35 weight %,
b) polymeric cationic emulsifiers Pₓ in an amount of from 0.5 to 10 weight %,
c) surfactant(s) Sₓ in an amount of from 4 to 12 weight %,
d) additive(s) Aₓ in an amount of from 0 to 10 weight % and
e) water in an amount of from 33 to 80.5 weight %,
   based on the total weight of the emulsion,
a) oil(s) in an amount of from 15 to 35 weight %,
b) polymeric cationic emulsifiers Pₓ in an amount of from 0.5 to 10 weight %,
c) surfactant(s) Sₓ in an amount of from 4 to 12 weight %,
d) additive(s) Aₓ in an amount of 0 weight % and
e) water in an amount of from 33 to 80.5 weight %,
   based on the total weight of the emulsion,
a) oil(s) in an amount of from 15 to 35 weight %,
b) polymeric cationic emulsifiers Pₓ in an amount of from 0.5 to 10 weight %,
c) surfactant(s) Sₓ in an amount of from 4 to 12 weight %,
d) additive(s) Aₓ in an amount of 0 weight % and
e) water in an amount of from 33 to 80.5 weight %,
   based on the total weight of the emulsion,
a) oil(s) in an amount of from 15 to 30 weight %,
b) polymeric cationic emulsifiers Pₓ in an amount of from 0.5 to 30 weight %,
c) surfactant(s) Sₓ in an amount of 0 weight %,
d) additive(s) Aₓ in an amount of from 2 to 8 weight % and
e) water in an amount of from 50 to 80 weight %,
   based on the total weight of the emulsion
   or
a) oil(s) in an amount of from 15 to 30 weight %,
b) polymeric cationic emulsifiers Pₓ in an amount of from 0.5 to 5 weight %,
c) surfactant(s) Sₓ in an amount of 0 weight %,
d) additive(s) Aₓ in an amount of 0 weight % and
e) water in an amount of from 50 to 80 weight %,
   based on the total weight of the emulsion.

Not only the amount but also the nature of the components of the inventive composition comprising an emulsion can be chosen advantageously.

The oil(s) used in the emulsion of the present invention is/are selected from the group consisting of:
a1) polyolefines,
a2) silicone oils, a3) natural oil(s),
a4) mineral oils, having a boiling point at atmospheric pressure of 150° C. or higher,
a5) esters of C₁₋₁₀- to C₂₋₆-carboxylic acid with C₈-C₂₄-alcohols,
   and/or mixtures thereof.

Oils according to the invention refer to hydrophobic substances, which are liquid at ambient temperature.

In general polyolefine(s) as used in the present invention is/are a chemical compound(s) consisting of carbon and hydrogen atoms. The polyolefine(s) can be linear, e.g. polyethylene, or can have side chains, e.g. polypropylene having methyl-side chains, which side chains may be that long that comb-like structures are found, or can be co- or ter-polymers, e.g. ethene/propenecopolymer or ethane/propene/hexane-terpolymer. It is particularly preferred, when the polyolefine(s) is/are substantially homopolymers, i.e. the degree of co- or ter-monomer is below 10 mass %, preferably below 5 mass % based on the mass of the polymer. It is particularly preferred, if the polymer(s) is/are homopolymers, i.e. they consist of only one kind of monomer.

In particular a composition comprising an emulsion, wherein the polyolefine(s) a1) contained in said emulsion is/are selected from the group consisting of: polyethylene, polypropylene, polybutylene and polyisobutylene is preferred. The composition containing an emulsion wherein the emulsion can comprise one or more polyolefine(s). A composition comprising an emulsion, which only comprises one polyolefine a1) is preferred. A composition comprising an emulsion, which only comprises polyisobutylene as polyolefine a1) is particularly preferred. The polyolefines a1) can be prepared by the usual procedures (Ullmann's Encyclopedia of Industrial Chemistry, Polyolefins, Whiteley, Heggs, Koch, Mawer, Immel, Wiley-VCH Verlag GmbH & Co. KGaA, Weinheim 2005). The production of polyisobutylene is described e.g. in WO 02/06359 and WO 96/40808 in even more detail. The polyolefine(s) a1) preferably has/have of molar mass (Mₙ) of at least 250 g/mol, preferably at least 350 g/mol and more preferred at least 500 g/mol. The polyolefine(s) a1) have a maximum molar mass Mₙ of 10.000 g/mol, preferably 5000 g/mol and more preferred of 2500 g/mol. The most preferred range of the molar mass Mₙ of polyolefins a1) is from 550 to 2000 g/mol.

Suitable silicone oils a2) contained within the emulsion of the present invention are, for example, linear polydimethylsiloxanes, poly(methylphenylsiloxanes), cyclic siloxanes and mixtures thereof. The number-average molecular weight of the polydimethylsiloxanes and poly(methylphenylsiloxanes) is preferably in a range from about 1000 to 150 000 g/mol. Preferred cyclic siloxanes have 4- to 8-membered rings. Suitable cyclic siloxanes are commercially available, for example, under the name cyclomethicone.

Preferred natural oils a3) contained within the emulsion of the present invention are, for example, castor oil, soya oil, peanut oil, olive oil, sunflower oil, sesame oil, avocado oil, cocoa butter, almond oil, peach kernel oil, ricinus oil, cod-liver oil, pig fat, spermaceti, spermaceti oil, sperm oil, wheatgerm oil, macadamia nut oil, evening primrose oil, jojoba oil; fatty alcohols, such as lauryl alcohol, myristyl alcohol, cetyl alcohol, stearyl alcohol, oleyl alcohol, cetyl alcohol; fatty acids, such as myristic acid, stearic acid, palmitic acid, oleic acid, linoleic acid, linolenic acid and saturated, unsaturated and substituted fatty acids different therefrom; and mixtures of the abovementioned oil and fat components.

Preferred mineral oils a4) contained within the emulsion of the present invention available under the names mineral oil light, mineral oil heavy, paraffin liquid or Nujol, that are liquid at room temperature.

Also the composition comprising the emulsion according to the invention comprises within said emulsion polymer(s) Pₓ, wherein Px is the product of the polymerization of
A) one or more cationic ethylenically unsaturated monomers (monomer A),
B) one or more linear or branched alkyl(meth)acrylates (monomer B),
C) from 0 to 30 weight % of one or more C₃-C₈ monoethylenically unsaturated carboxylic acids (monomer C).

Monomer A is a cationic monoethylenically unsaturated monomer which is at least partially soluble in water of the reaction solvent, or in the other monomers if no water or solvent is used. Suitable examples of monomer A are (3-acrylamidopropyl)-trimethylammonium chloride (APTAC), diallyl dimethyl ammonium chloride (DADMAC), (3-methacrylamidopropyl)trimethylammonium chloride (MAPTAC), dimethylaminopropylacrylat methochlorid, dimethylaminopropylmethacrylat methochlorid. Monomer A is preferably DADMAC.

Monomer B is a linear or branched alkyl(meth)acrylate, preferably a C₁₀-C₃₀ alkyl(meth)acrylate, even more preferably a C₁₂-C₂₀ alkyl(meth)acrylate. Suitable monomers B include linear and branched alkyl esters of (meth)acrylic acid, such as octyl acrylate, dodecyl acrylate, lauryl acrylate, cetyl acrylate, octadecyl acrylate, isodecyl acrylate, 2-ethylhexyl acrylate. Monomer B is preferably lauryl acrylate (LA).

Monomer C is a C₃-C₈ monoethylenically unsaturated carboxylic acid. Suitable examples of monomer C include acrylic acid, methacrylic acid, crotonic acid, maleic acid, maleic anyhydride, fumaric acid, itaconic acid and alkyli and metal salts thereof. Monomer C is preferably acrylic acid (AA).

Preferably the polymer Pₓ is the product of the polymerization of
A) diallyl dimethyl ammonium chloride,
B) one or more linear or branched alkyl(meth)acrylates,
C) from 0 to 30 weight % of acrylic acid.

With regard to the amounts in which the respective monomers are present in the polymer Pₓ, there are preferred ranges. Thus the polymer Pₓ is preferably the product of the polymerization of
A) from 60 to 95 weight % of monomer A,
B) from 5 to 45 weight % of monomer B
C) from 0 to 30 weight % of monomer C.

Even more preferred is a polymer Pₓ which is the product of the polymerization of:
A) from 70 to 90 weight % of monomer A,
B) from 10 to 35 weight % of monomer B
C) from 5 to 20 weight % of monomer C.

Another preferred embodiment is a polymer Pₓ which is the product of the polymerization of:
A) from 70 to 90 weight % of monomer A,
B) from 10 to 35 weight % of monomer B
C) 0 weight % of monomer C.

A composition comprising an emulsion, wherein the emulsion surfactant(s) Sₓ is/are selected from the group consisting of:
c1) nonionic surfactants,
c2) anionic surfactants and
c3) cationic surfactants is preferred.

Surfactants normally consist of a hydrophobic and a hydrophilic part. Thereby the hydrophobic part normally has a chain length of 4 to 20 C-atoms, preferably 6 to 19 C-atoms and particularly preferred 8 to 18 C-atoms. The functional unit of the hydrophobic group is generally an OHgroup, whereby the alcohol can be linear or branched. The hydrophilic part generally consists substantially of alkoxylated units (e.g. ethylene oxide (EO), propylene oxide (PO) and/or butylene oxide (BO), whereby generally 2 to 30, preferably 5 to 20 of these alkoxylated units are annealed, and/or charged units such as sulfate, sulfonate, phosphate, carbonic acids, ammonium and ammonium oxide.

Examples of anionic surfactants are: carboxylates, sulfonates, sulfo fatty acid methylesters, sulfates, phosphates. Examples for cationic surfactants are: quartery ammonium compounds. Examples for betaine-surfactants are: alkyl betaines. Examples for non-ionic compounds are: alcohol alkoxylates.

A “carboxylate” is a compound which comprises at least one carboxylate-group in the molecule. Examples of carboxylates, which can be used according to the present invention, are
soaps—e.g. stearates, oleates, cocoates of alkali metals or of ammonium,
ethercarboxylates—e.g. Akypo® RO 20, Akypo® RO 50, Akypo® RO 90.

A “sulfonate” is a compound which comprises at least one sulfonate-group in the molecule. Examples of sulfonates, which can be used according to the invention, are
alkyl benzene sulfonates—e.g. Lutensit® A-LBS, Lutensit® A-LBN, Lutensit® ALBA, Marlon® AS3, Maranil® DBS,
alkyl sulfonates—e.g. Alscoap OS-14P, BIO-TERGE® AS-40, BIO-TERGE® AS-40 CG, BIO-TERGE® AS-90 Beads, Calimulse® AOS-20, Calimulse® AOS-40, Calsoft®AOS-40, Colonial® AOS-40, Elfan® OS 46, Ifrapon® AOS 38, Ifrapon® AOS 38 P, Jeenate® AOS-40, Nikkol® OS-14, Norfox® ALPHA XL, POLYSTEP® A-18, Rhodacal® A-246L, Rhodacal® LSS-40/A,
sulfonated oils such as Turkish red oil,
olefine sulfonates,
aromatic sulfonates—e.g. Nekal® BX, Dowfax® 2A1.

A “sulfo fatty acid methylester” is a compound having the following general formula (I):

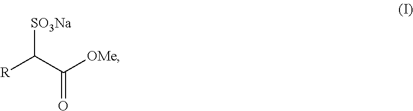

wherein R has 10 to 20 C-atoms; preferably 12 to 18 and particularly preferred 14 to 16 C-atoms.

A “sulfate” is a compound which comprises at least one SO₄-group in the molecule. Examples of sulfates, which can be used according to the present invention, are
fatty acid alcohol sulfates such as coco fatty alcohol sulfate (CAS 97375-27-4)—e.g. EMAL® 10G, Dispersogen® SI, Elfan® 280, Mackol® 100N,
other alcohol sulfates—e.g. Emal® 71, Lanette® E,
coco fatty alcohol ethersulfates—e.g. Emal® 20C, Latemul® E150, Sulfochem® ES-7, Texapon® ASV-70 Spec., Agnique SLES-229-F, Octosol 828, POLYSTEP® B-23, Unipol® 125-E, 130-E, Unipol® ES-40,
other alcohol ethersulfates—e.g. Avanel® 5-150, Avanel® S 150 CG, Avanel® S 150 CG N, Witcolate® D51-51, Witcolate® D51-53.

A “phosphate” is a compound which comprises at least one PO₄-group. Examples of phosphates, which can be used according to the present invention, are
alkyl ether phosphates—e.g. Maphos® 37P, Maphos® 54P, Maphos® 37T, Maphos® 210T and Maphos® 210P,
phosphates such as Lutensit® A-EP,
alkyl phosphates.

When producing the chemical composition of the present invention the anionic surfactants are preferably added as salts. Acceptable salts are e.g. alkali metal salts, such as sodium-, potassium- and lithium salts, and ammonium salts, such as hydroxylethylammonium-, di(hydroxyethyl)ammonium- and tri(hydroxyethyl)ammonium salts.

One group of the cationic surfactants are the quarternary ammonium compounds.

A “quarternary ammonium compound” is a compound which comprises at least one R₄N⁺ group per molecule. Examples of counter ions, which are useful in the quarternary ammonium compounds, are:
halogens, methosulfates, sulfates and carbonates of coco fat-, sebaceous fat- or cetyl/oleyltrimethylammonium.

Particularly suitable cationic surfactants are:
N,N-dimethyl-N-(hydroxy-C₇-C₂₅-alkyl)ammonium salts;
mono- and di-(C₇-C₂₅-alkyl)dimethylammonium compounds, which were quarternised with alkylating agents
esterquats, especially mono-, di- and trialkanolamines, quarternary esterified by C₈-C₂₂-carbonic acids;
imidazolinquats, especially 1-alkylimidazoliniumsalts of formula II or III

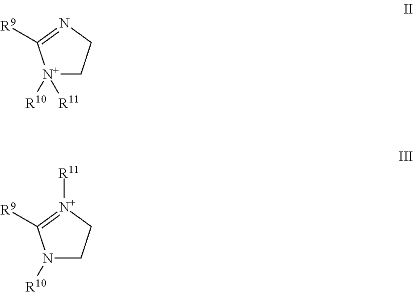

wherein the variables have the following meaning:
R⁹ C₁-C₂₅-alkyl or C₂-C₂₅-alkenyl;
R¹⁰ C₁-C₄-alkyl or hydroxy-C₁-C₄-alkyl;
R¹¹ C₁-C₄-alkyl, hydroxy-C₁-C₄-alkyl or a rest R¹—(CO)—X—(CH₂)ₘ—(X:—O— or —NH—; m: 2 or 3),
whereby at least one rest R⁹ is C₇-C₂₂-alkyl.

A “betain-surfactant” is a compound, which comprises under conditions of use—i.e. in the case of textile washing under normal pressure and at temperatures of from room temperature to 95° C.—at least one positive charge and at least one negative charge. An “alkylbetain” is a betain-surfactant which comprises at least one alkyl-unit per molecule. Examples of betain-surfactants which can be used according to the invention, are

Cocamidopropylbetain—e.g. MAFO® CAB, Amonyl® 380 BA, AMPHOSOL® CA, AMPHOSOL® CG, AMPHOSOL® CR, AMPHOSOL® HCG; AMPHOSOL® HCG-50, Chembetaine® C, Chembetaine® CGF, Chembetaine® CL, Dehyton® PK, Dehyton® PK 45, Emery® 6744, Empigen® BS/F, Empigen® BS/FA, Empigen® BS/P, Genagen® CAB, Lonzaine® C, Lonzaine® CO, Mirataine® BET-C-30, Mirataine® CB, Monateric® CAB, Naxaine® C, Naxaine® CO, Norfox® CAPB, Norfox® Coco Betaine, Ralufon® 414, TEGO®-Betain CKD, TEGO® Betain E KE 1 TEGO®-Betain F, TEGO®-Betain F 50 and aminoxides such as alkyl dimethyl amineoxide, i.e. compounds of general formula (IV)

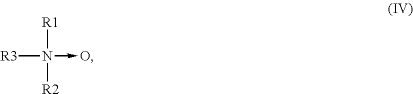

whereby R1, R2 and R3 are chosen independently from each other of an aliphatic, cyclic or tertiary alkyl- or amido alkyl-moiety, e.g. Mazox® LDA, Genaminox®, Aromox® 14 DW 970.

Non-ionic surfactants are interfacially active substances having a head group, which is an uncharged, polar, hydrophilic group, not carrying an ionic charge at neutral pH, and which head group makes the non-ionic surfactant water soluble. Such a surfactant adsorbs at interfaces and aggregates to micelles above the critical micelle concentration (cmc). According to the type of the hydrophilic head group it can be distinguished between (oligo)oxyalkylene-groups, especially (oligo)oxyethylene-groups, (polyethyleneglycol-groups), including fatty alcohol polyglycole ether (fatty alcohol alkoxylates), alkylphenol polyglycolether and fatty acid ethoxylates, alkoxylated triglycerides and mixed ethers (polyethylene glycolether alcoxylated on both sides); and carbohydrate-groups, including e.g. alkyl polyglucosides and fatty acid-N-methylglucamides.

Alcohol alkoxylates, are based on a hydrophobic part having a chain length of 4 to 20 C-atoms, preferably 6 to 19 C-atoms and particularly preferred 8 to 18 C-atoms, whereby the alcohol can be linear or branched, and a hydrophilic part, which can be alkoxylated units, e.g. ethylene oxide (EO), propylene oxide (PO) and/or butylene oxide (BuO), having 2 to 30 repeating units. Examples are besides others Lutensol® XP, Lutensol® XL, Lutensol® ON, Lutensol® AT, Lutensol® A, Lutensol® AO, Lutensol® TO.

Alcoholphenolalkoxylates are compounds according to general formula (V),

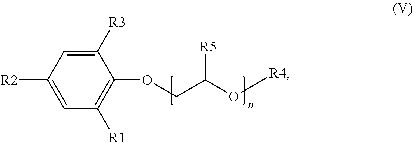

which can be produced by addition of alkylene oxide, preferably ethylene oxide onto alkyle phenoles. Preferably R4=H. It is also preferred, if R5=H,—since than it is EO; in the same way it is preferred if R5=CH₃, since than it is PO, or, if R5=CH₂CH₃ since than it is BuO. A compound is especially preferred, in which octyl-[(R1=R3=H, R2=1,1,3,3-tetramethylbutyl(diisobutylene)], nonyl-[(R1=R3=H, R2=1,3,5-trimethylhexyl(tripropylene)], dodecyl-, dinonyl- or tributylphenolpolyglycolether (e.g. EO, PO, BuO), R—C₆H₄—O-(EO/PO/BuO)n with R=C8 to C12 and n=5 to 10, are present. Non-limiting examples of such compounds are: Norfox® OP-102, Surfonic® OP-120, T-Det® O-12.

Fatty acid ethoxylates are fatty acid esters which have been treated with different amounts of ethylene oxide (EO).

Triglycerides are esters of the glycerols (glycerides) in which all three hydroxy-groups have been esterified using fatty acids. These can be modified by alkylene oxides.

Fatty acid alkanol amides are compounds of general formula (VI)

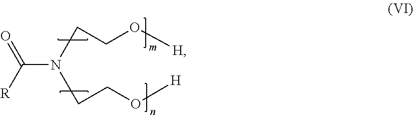

which comprise at least one amide-group having one alkyl moiety R and one or two alkoxyl-moiety(ies), whereby R comprises 11 to 17 C-atoms and 1≦m+n≦5.

Alkylpolyglycosides are mixtures of alkylmonoglucosides (alkyl-α-D- and -β-D-glucopyranoside plus small amounts of -glucofuranoside), alkyldiglucosides (-isomaltosides, maltosides and others) and alkyloligoglucosides (-maltotriosides, -tetraosides and others). Alkylpolyglycosides are among other routes accessible by acid catalysed reaction (Fischerreaction) from glucose (or starch) or from n-butylglucosides with fatty alcohols. Alkylpolyglycosides fit general formula (VII)

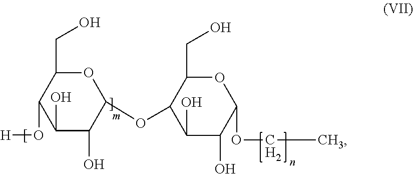

with
m=0 to 3 and
n=4 to 20.

One example is Lutensol® GD70.

In the group of non-ionic N-alkylated, preferably N-methylated, fatty acid amides of general formula (VIII)

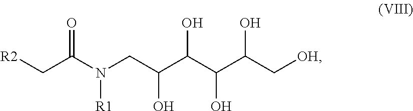

R1 is a n-C₁₋₂-alkyl-moiety, R2 an alkyl-moiety having 1 to 8 C-atoms. R2 preferably is methyl. An emulsion, wherein the additive(s) Aₓ is/are selected from the group consisting of: disinfectant, dye, acid, base, complexing agent, biocide, hydrotope, thickener, builder, cobuilder, enzyme, bleaching agent, bleach activator, bleaching catalyst, corrosion inhibitor, dye protection additive, dye transfer inhibitor, anti-greying agent, soil-release-polymer, fiber protection agent, silicon, bactericide, preserving agent, organic solvent, solubility adjustor, solubility enhancer, perfume, gel formers, dyes, pigments, photoprotective agents, consistency regulators, antioxidants, bleaches, care agents, tints, tanning agents, humectants, refatting agents, collagen, protein hydrolysates, lipids, emollients, softeners, antifoams, antistats, resins, solvents, solubility promoters, neutralizing agents, stabilizers, sterilizing agents, propellants, drying agents, opacifiers is preferred.

Disinfectants can be: oxidation agents, halogens such as chlorine and iodine and substances, which release the same, alcohols such as ethanol, 1-propanol and 2-propanol, aldehydes, phenoles, ethylene oxide, chlorohexidine and mecetroniummetilsulfate.

The advantage of using disinfectants is that pathogenic germs can hardly grow. Pathogenic germs can be: bacteria, spores, fungi and viruses.

Dyes can be besides others: Acid Blue 9, Acid Yellow 3, Acid Yellow 23, Acid Yellow 73, Pigment Yellow 101, Acid Green 1, Acid Green 25.

Acids are compounds that can advantageously be used to solve or to avoid scaling. Non-limiting examples of acids are formic acid, acetic acid, citric acid, hydrochloric acid, sulfuric acid and sulfonic acid.

Bases are compounds which are useful for adjusting a preferable pH-range for complexing agents. Examples of bases, which can be used according to the present invention, are: NaOH, KOH and amine ethanol.

As inorganic builder the following are especially useful:
crystalline and amorphous alumino silicates having ion exchanging properties, such as zeolites: different types of zeolites are useful, especially those of type A, X, B, P, MAP and HS in their Na-modification or in modifications in which Na is partially substituted by other cat ions such as Li, K, Ca, Mg or ammonium;
crystalline silicates, such as disilicates and layered-silicates, e.g. δ- and β-Na₂Si₂O₅. The silicates can be used as alkali metal-, earth alkali metal- or ammonium salts, the Na-, Li- and Mg-silicates are preferred;
amorphous silicates, such as sodium metasilicate and amorphous disilicate;
carbonates and hydrogencarbonates: These can be used as alkali metal-, earth alkali metal- or ammonium salts. Na-, Li- and Mg-carbonates and -hydrogen carbonate, especially sodium carbonate and/or sodium hydrogen carbonate are preferred;
polyphosphates, such as pentanatriumtriphosphate.

### Useful as Oligomeric and Polymeric Cobuilders are:

Oligomeric and polymeric carbonic acids, such as homopolymers of acrylic acid and aspartic acid, oligomaleic acid, copolymers of maleic acid and acrylic acid, methacrylic acid or C₂-C₂₂-olefines, e.g. isobutene or long chain α-olefines, vinyl-C₁-C₈-alkylether, vinylacetate, vinylpropionate, (meth)acryl acid ester of C₁-C₈-alcohols and styrene. Preferred are the homopolymers of acrylic acid and the copolymers of acrylic acid with maleic acid. The oligomeric and polymeric carbonic acids preferably are used as acids or as sodium salts.

Chelating agents are compounds which can bind cations. They can be used to reduce water hardness and to precipitate heavy metals. Examples of complexing agents are: NTA, EDTA, MGDA, DTPA, DTPMP, IDS, HEDP, 13-ADA, GLDA, citric acid, oxodisuccinic acid and butanetetracarbonic acid. The advantage of the use of these compounds lies in the fact that many compounds, which serve as cleaning agents, are more active in soft water. In addition to that scaling can be reduced or even be avoided. By using such compounds there is no need to dry a cleaned surface. This is an advantage in the work flow.

Useful anti greying agents are e.g. carboxymethylcellulose and graft polymers of vinyl acetate on polyethylene glycol.

Useful bleaching agents are e.g. adducts of hydrogen peroxide as inorganic salts, such as sodium perborate-monohydrate, sodium perborate-tetrahydrate and sodium carbonate-perhydrate, and percarbonic acids, such as phthalimidopercapronic acid.

As bleach activators compounds such as N,N,N′,N′-tetraacetylethylendiamine (TAED), sodiump-nonanoyloxybenzenesulfonate and N-methylmorpholiniumacetonitrilemethyl-sulfate are useful.

Useful enzymes are e.g. proteases, lipases, amylases, cellulases, mannanases, oxidases and peroxidases.

Useful as dye transfer inhibitors are e.g. homo-, co- and graft-polymers of 1-vinylpyrrolidone, 1-vinylimidazol or 4-vinylpyridine-N-oxide. Also homo- and copolymers of 4-vinylpyridin, which have been treated with chloroacetic acid are useful dye transfer inhibitors.

Biocides are compounds which kill bacteria. An example of a biocide is glutaric aldehyde. The advantage of the use of biocides is that the spreading of pathogenic germs is counteracted.

Hydrotropes are compounds which enhance the solubility of the surfactant/the surfactants in the chemical composition. An example is: Cumolsulfonate.

Thickeners are compounds which enhance the viscosity of the chemical composition. Non-limiting examples of thickeners are: polyacrylates and hydrophobically modified polyacrylates. The advantage of the use of thickeners is, that liquids having a higher viscosity have a longer residence time on the surface to be treated in the cases this surface is inclined or even vertical. This leads to an enhanced time of interaction.

An emulsion which has a content of organic solvent below 50 mg/kg of emulsion is particularly preferred.

An emulsion according as described above, which is stable for more than 2 days according to the phase-stability-test forms a preferred embodiment of the present invention.

### Phase-Stability-Test:

The stability of the emulsion is tested by visual inspection via the phase-stability-test. After preparation, the emulsion is stored in a closed graduated cylinder (Hirschmann Duran 100 ml volume, NS24/29) at room temperature without agitation. After 1 h, 4 h, 24 h and 48 h, the emulsion is inspected for phase separation.
The emulsion is defined stable when no visually observable phase separation occurs after 48 h.
The emulsion is defined as re-emulsifiable when phase separation occurs after 48 h, but the emulsion is immediately reformed upon slight shaking or stirring with low shear, for example with a magnetic stirrer bar, and the reformed emulsion is stable again for at least four hours.
The emulsion is defined unstable, when phase separation occurs shortly after preparation and the emulsion can not be reformed by slight shaking or stirring with low shear, for example with a magnetic stir bar.

A process for making an emulsion as described above, comprising the steps of: combining polyolefine(s), polymer(s) Pₓ, water and optionally oil(s) Oₓ, surfactant(s) Sₓ and additives Aₓ and homogenizing said components in a mechanical mixer without the use of a solvent forms another aspect of the present invention.

Regarding the details of the process different versions are possible.

The emulsions can be prepared by processes known in the literature, for example in Heusch, R., “Ullmann's Encyclopedia of Industrial Chemistry”, Chapter “Emulsions”, 1-47, Wiley-VCH, 2000 (DOI: 10.1002/14356007.a09_{—}297) or in Kostansek, E., “Kirk-Othmer Encyclopedia of Chemical Technology”, Vol. 10, 113-133, Chapter “Emulsions”, John Wiley & Sons 2003 (DOI: 10.1002/0471238961.0513211206180902.a01.pub2).

Suitable emulsifying machines are for example high-speed stirrers, agitation or impact machines, emulsifier centrifuges, colloid mills, metering pumps (atomizers), vibrators, ultrasonic generators and homogenizers.

In one preferred embodiment of the invention, the preparation of the emulsion is achieved via a solvent-free route (a solvent being a substance with a boiling point below 150° C. that can dissolve the oil(s) a), for example o-xylene) by combination of the components, comprising oil(s), polymer(s) Pₓ, water, optionally surfactant, and optionally further additives such as defoamers etc., and homogenization with a suitable device, like for example a high-shear mixer or for example a high-pressure homogenizer, optionally at elevated temperatures.

The step of combining the components can vary: in one preferred embodiment, polymer(s) Pₓ is dissolved in the oil(s), optionally additional components, and then combined with the water phase, comprising water, optionally surfactant and additional components, then added to the consumer product treatment composition.

In another preferred embodiment, polymer(s) Pₓ is dissolved in the water phase, comprising water, optionally surfactant and/or additional components, and then combined with the oil phase, comprising oil(s) and optionally additional components, then added to the consumer product treatment composition.

In another preferred embodiment of the invention, the preparation of the emulsion is achieved via a solvent route. The components of the emulsion, comprising oil(s) a) and polymer(s) Pₓ, are dissolved in a solvent, for example o-xylene, in a stirred reactor, optionally at elevated temperatures. After complete dissolution, water is added to the solution and the mixture is distilled, optionally under addition of water steam, at elevated temperature (above 80° C.) until the solvent is removed.

The use of an emulsion as described above in car wash, forms another aspect of the present invention.

Aspects of the invention include the use of the emulsion compositions disclosed herein in laundry detergent compositions (e.g., TIDE™), hard surface cleaners (e.g., MR CLEAN™), automatic dishwashing liquids (e.g., CASCADE™), and dishwashing liquids (e.g., DAWN™). Non-limiting examples of cleaning compositions may include those described in U.S. Pat. Nos. 4,515,705; 4,537,706; 4,537,707; 4,550,862; 4,561,998; 4,597,898; 4,968,451; 5,565,145; 5,929,022; 6,294,514; and 6,376,445. The cleaning compositions disclosed herein are typically formulated such that, during use in aqueous cleaning operations, the wash water will have a pH of between about 6.5 and about 12, or between about 7.5 and 10.5. Liquid dishwashing product formulations typically have a pH between about 6.8 and about 9.0. Cleaning products are typically formulated to have a pH of from about 7 to about 12. Techniques for controlling pH at recommended usage levels include the use of buffers, alkalis, acids, etc., and are well known to those skilled in the art.

Fabric treatment compositions disclosed herein typically comprise a fabric softening active (“FSA”) and a nonionic care agent disclosed herein. Suitable fabric softening actives, include, but are not limited to, materials selected from the group consisting of quats, amines, fatty esters, sucrose esters, silicones, dispersible polyolefins, clays, polysaccharides, fatty oils, polymer latexes and mixtures thereof.

Additional Fabric and/or Homecare Ingredients

The disclosed compositions may include additional adjunct ingredients. Adjunct ingredients include, but are not limited to, deposition aids, bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids and/or pigments. The adjunct ingredients are in addition to an materials that are specifically recited in an embodiment that is disclosed and/or claimed. Each adjunct ingredient may be not essential to Applicants' compositions. Thus, certain embodiments of Applicants' compositions do not contain one or more of the following adjuncts materials: a deposition aids, bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids and/or pigments. However, when one or more adjuncts are present, such one or more adjuncts may be present as detailed below The following is a non-limiting list of suitable additional adjuncts.

Deposition Aid—In one aspect, the fabric treatment composition may comprise from about 0.01% to about 10%, from about 0.05 to about 5%, or from about 0.15 to about 3% of a deposition aid. Suitable deposition aids are disclosed in, for example, U.S. patent application Ser. No. 12/080,358.

In one aspect, the deposition aid may be a cationic or amphoteric polymer. In another aspect, the deposition aid may be a cationic polymer. Cationic polymers in general and their method of manufacture are known in the literature. In one aspect, the cationic polymer may have a cationic charge density of from about 0.005 to about 23, from about 0.01 to about 12, or from about 0.1 to about 7 milliequivalents/g, at the pH of intended use of the composition. For amine-containing polymers, wherein the charge density depends on the pH of the composition, charge density is measured at the intended use pH of the product. Such pH will generally range from about 2 to about 11, more generally from about 2.5 to about 9.5. Charge density is calculated by dividing the number of net charges per repeating unit by the molecular weight of the repeating unit. The positive charges may be located on the backbone of the polymers and/or the side chains of polymers.

Non-limiting examples of deposition enhancing agents are cationic or amphoteric, polysaccharides, proteins and synthetic polymers. Cationic polysaccharides include cationic cellulose derivatives, cationic guar gum derivatives, chitosan and derivatives and cationic starches. Cationic polysaccharides have a molecular weight from about 50,000 to about 2 million, or even from about 100,000 to about 3,500,000. Suitable cationic polysaccharides include cationic cellulose ethers, particularly cationic hydroxyethylcellulose and cationic hydroxypropylcellulose. Examples of cationic hydroxyalkyl cellulose include those with the INCI name Polyquaternium10 such as those sold under the trade names Ucare™ Polymer JR 30M, JR 400, JR 125, LR 400 and LK 400 polymers; Polyquaternium 67 such as those sold under the trade name Softcat SK™, all of which are marketed by Amerchol Corporation, Edgewater N.J.; and Polyquaternium 4 such as those sold under the trade name Celquat™ H200 and Celquat™ L-200 available from National Starch and Chemical Company, Bridgewater, N.J. Other suitable polysaccharides include Hydroxyethyl cellulose or hydroxypropylcellulose quaternized with glycidyl C₁₂-C₂₂ alkyl dimethyl ammonium chloride. Examples of such polysaccharides include the polymers with the INCI names Polyquaternium 24 such as those sold under the trade name Quaternium LM 200 by Amerchol Corporation, Edgewater N.J. Cationic starches described by D. B. Solarek in Modified Starches, Properties and Uses published by CRC Press (1986) and in U.S. Pat. No. 7,135,451, col. 2, line 33-col. 4, line 67. Cationic galactomannans include cationic guar gums or cationic locust bean gum. An example of a cationic guar gum is a quaternary ammonium derivative of Hydroxypropyl Guar such as those sold under the trade name Jaguar® C13 and Jaguar® Excel available from Rhodia, Inc of Cranbury N.J. and N-Hance by Aqualon, Wilmington, Del.

Another group of suitable cationic polymers includes those produced by polymerization of ethylenically unsaturated monomers using a suitable initiator or catalyst, such as those disclosed in U.S. Pat. No. 6,642,200.

Suitable polymers may be selected from the group consisting of cationic or amphoteric polysaccharide, polyethylene imine and its derivatives, and a synthetic polymer made by polymerizing one or more cationic monomers selected from the group consisting of N,N-dialkylaminoalkyl acrylate, N,N-dialkylaminoalkyl methacrylate, N,N-dialkylaminoalkyl acrylamide, N,N-dialkylaminoalkylmethacrylamide, quaternized N,N dialkylaminoalkyl acrylate quaternized N,N-dialkylaminoalkyl methacrylate, quaternized N,N-dialkylaminoalkyl acrylamide, quaternized N,N-dialkylaminoalkylmethacrylamide, Methacryloamidopropyl-pentamethyl-1,3-propylene-2-ol-ammonium dichloride, N,N,N,N′,N′,N″,N″-heptamethyl-N″-3-(1-oxo-2-methyl-2-propenyl)aminopropyl-9-oxo-8-azo-decane-1,4,10-triammonium trichloride, vinylamine and its derivatives, allylamine and its derivatives, vinyl imidazole, quaternized vinyl imidazole and diallyl dialkyl ammonium chloride and combinations thereof, and optionally a second monomer selected from the group consisting of acrylamide, N,N-dialkyl acrylamide, methacrylamide, N,N-dialkylmethacrylamide, C₁-C₁₂ alkyl acrylate, C₁-C₁₂ hydroxyalkyl acrylate, polyalkylene glyol acrylate, C₁-C₁₂ alkyl methacrylate, C₁-C₁₂ hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and derivatives, acrylic acid, methacrylic acid, maleic acid, vinyl sulfonic acid, styrene sulfonic acid, acrylamidopropylmethane sulfonic acid (AMPS) and their salts. The polymer may optionally be branched or cross-linked by using branching and crosslinking monomers. Branching and crosslinking monomers include ethylene glycoldiacrylate divinylbenzene, and butadiene. In another aspect, the treatment composition may comprise an amphoteric deposition aid polymer so long as the polymer possesses a net positive charge. Said polymer may have a cationic charge density of about 0.05 milliequivalents/g. to about 18 milliequivalents/g.

In another aspect, the deposition aid may be selected from the group consisting of cationic polysaccharide, polyethylene imine and its derivatives, poly(acrylamide-codiallyldimethylammonium chloride), poly(acrylamide-methacrylamidopropyltrimethyl ammonium chloride), poly(acrylamide-co-N,N-dimethylaminoethyl acrylate) and its quaternized derivatives, poly(acrylamide-co-N,N-dimethylaminoethyl methacrylate) and its quaternized derivative, poly(hydroxyethylacrylate-co-dimethylaminoethyl methacrylate), poly(hydroxpropylacrylate-co-dimethylaminoethyl methacrylate), poly(hydroxpropylacrylate-co-methacrylamidopropyltrimethylammonium chloride), poly(acrylamide-codiallyldimethylammonium chloride-co-acrylic acid), poly(acrylamide-methacrylamidopropyltrimethyl ammonium chloride-co-acrylic acid), poly(diallyldimethyl ammonium chloride), poly(vinylpyrrolidone-co-dimethylaminoethyl methacrylate), poly(ethyl methacrylate-co-quaternized dimethylaminoethyl methacrylate), poly(ethyl methacrylate-cooleyl methacrylate-co-diethylaminoethyl methacrylate), poly(diallyldimethylammonium chloride-co-acrylic acid), poly(vinyl pyrrolidone-co-quaternized vinyl imidazole) and poly(acrylamide-co-Methacryloamidopropyl-pentamethyl-1,3-propylene-2-ol-ammonium dichloride), Suitable deposition aids include Polyquaternium-1, Polyquaternium-5, Polyquaternium-6, Polyquaternium-7, Polyquaternium-8, Polyquaternium-11, Polyquaternium-14, Polyquaternium-22, Polyquaternium-28, Polyquaternium-30, Polyquaternium-32 and Polyquaternium-33, as named under the International Nomenclature for Cosmetic Ingredients. In one aspect, the deposition aid may comprise polyethyleneimine or a polyethyleneimine derivative. A suitable polyethyleneinine useful herein is that sold under the trade name Lupasol® by BASF, AG, and Ludwigshafen, Germany.

In another aspect, the deposition aid may comprise a cationic acrylic based polymer. In a further aspect, the deposition aid may comprise a cationic polyacrylamide. In another aspect, the deposition aid may comprise a polymer comprising polyacrylamide and polymethacrylamidopropyl trimethylammonium cation. In another aspect, the deposition aid may comprise poly(acrylamide-N-dimethyl aminoethyl acrylate) and its quaternized derivatives. In this aspect, the deposition aid may be that sold under the trade name Sedipur®, available from BTC Specialty Chemicals, a BASF Group, Florham Park, N.J. In a yet further aspect, the deposition aid may comprise poly(acrylamide-co-methacrylamidopropyltrimethyl ammonium chloride). In another aspect, the deposition aid may comprise a non-acrylamide based polymer, such as that sold under the trade name Rheovis® CDE, available from Ciba Specialty Chemicals, a BASF group, Florham Park, N.J., or as disclosed in USPA 2006/0252668.

In another aspect, the deposition aid may be selected from the group consisting of cationic or amphoteric polysaccharides. In one aspect, the deposition aid may be selected from the group consisting of cationic and amphoteric cellulose ethers, cationic or amphoteric galactomannan, cationic guar gum, cationic or amphoteric starch, and combinations thereof.

Another group of suitable cationic polymers may include alkylamine-epichlorohydrin polymers which are reaction products of amines and oligoamines with epichlorohydrin, for example, those polymers listed in, for example, U.S. Pat. Nos. 6,642,200 and 6,551,986. Examples include dimethylamine-epichlorohydrin-ethylenediamine, available under the trade name Cartafix® CB and Cartafix® TSF from Clariant, Basle, Switzerland.

Another group of suitable synthetic cationic polymers may include polyamidoamineepichlorohydrin (PAE) resins of polyalkylenepolyamine with polycarboxylic acid. The most common PAE resins are the condensation products of diethylenetriamine with adipic acid followed by a subsequent reaction with epichlorohydrin. They are available from Hercules Inc. of Wilmington Del. under the trade name Kymene™ or from BASF AG (Ludwigshafen, Germany) under the trade name Luresin™. The cationic polymers may contain charge neutralizing anions such that the overall polymer is neutral under ambient conditions. Non-limiting examples of suitable counter ions (in addition to anionic species generated during use) include chloride, bromide, sulfate, methylsulfate, sulfonate, methylsulfonate, carbonate, bicarbonate, formate, acetate, citrate, nitrate, and mixtures thereof.

The weight-average molecular weight of the polymer may be from about 500 Daltons to about 5,000,000 Daltons, or from about 1,000 Daltons to about 2,000,000 Daltons, or from about 2,500 Daltons to about 1,500,000 Daltons, as determined by size exclusion chromatography relative to polyethylene oxide standards with RI detection. In one aspect, the MW of the cationic polymer may be from about 500 Daltons to about 37,500 Daltons.

Surfactants: The products of the present invention may comprise from about 0.11% to 80% by weight of a surfactant. In one aspect, such compositions may comprise from about 5% to 50% by weight of surfactant. Surfactants utilized can be of the anionic, nonionic, zwitterionic, ampholytic or cationic type or can comprise compatible mixtures of these types. Detergent surfactants useful herein are described in U.S. Pat. Nos. 3,664,961, 3,919,678, 4,222,905, 4,239,659, 6,136,769, 6,020,303, and 6,060,443.

Anionic and nonionic surfactants are typically employed if the fabric care product is a laundry detergent. On the other hand, cationic surfactants are typically employed if the fabric care product is a fabric softener.

Useful anionic surfactants can themselves be of several different types. For example, water-soluble salts of the higher fatty acids, i.e., “soaps”, are useful anionic surfactants in the compositions herein. This includes alkali metal soaps such as the sodium, potassium, ammonium, and alkylolammonium salts of higher fatty acids containing from about 8 to about 24 carbon atoms, or even from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap.

Useful anionic surfactants include the water-soluble salts, particularly the alkali metal, ammonium and alkylolammonium (e.g., monoethanolammonium or triethanolammonium) salts, of organic sulfuric reaction products having in their molecular structure an alkyl group containing from about 10 to about 20 carbon atoms and a sulfonic acid or sulfuric acid ester group. (Included in the term “alkyl” is the alkyl portion of aryl groups.) Examples of this group of synthetic surfactants are the alkyl sulfates and alkyl alkoxy sulfates, especially those obtained by sulfating the higher alcohols (C₈-C₁₈ carbon atoms).

Other useful anionic surfactants herein include the water-soluble salts of esters of α-sulfonated fatty acids containing from about 6 to 20 carbon atoms in the fatty acid group and from about 1 to 10 carbon atoms in the ester group; water-soluble salts of 2-acyloxy-alkane-1-sulfonic acids containing from about 2 to 9 carbon atoms in the acyl group and from about 9 to about 23 carbon atoms in the alkane moiety; water-soluble salts of olefin sulfonates containing from about 12 to 24 carbon atoms; and β-alkyloxy alkane sulfonates containing from about 1 to 3 carbon atoms in the alkyl group and from about 8 to 20 carbon atoms in the alkane moiety.

In another embodiment, the anionic surfactant may comprise a C₁₁-C₁₈ alkyl benzene sulfonate surfactant; a C₁₀-C₂₀ alkyl sulfate surfactant; a C₁₀-C₁₈ alkyl alkoxy sulfate surfactant, having an average degree of alkoxylation of from 1 to 30, wherein the alkoxy comprises a C₁-C₄ chain and mixtures thereof; a mid-chain branched alkyl sulfate surfactant; a mid-chain branched alkyl alkoxy sulfate surfactant having an average degree of alkoxylation of from 1 to 30, wherein the alkoxy comprises a C₁-C₄ chain and mixtures thereof; a C₁₀-C₁₈ alkyl alkoxy carboxylates comprising an average degree of alkoxylation of from 1 to 5; a C₁₂-C₂₀ methyl ester sulfonate surfactant, a C₁₀-C₁₈ alpha-olefin sulfonate surfactant, a C₆-C₂₀ sulfosuccinate surfactant, and a mixture thereof.

In addition to the anionic surfactant, the fabric care compositions of the present invention may further contain a nonionic surfactant. The compositions of the present invention can contain up to about 30%, alternatively from about 0.01% to about 20%, more alternatively from about 0.1% to about 10%, by weight of the composition, of a nonionic surfactant. In one embodiment, the nonionic surfactant may comprise an ethoxylated nonionic surfactant. Examples of suitable non-ionic surfactants are provided in U.S. Pat. Nos. 4,285,841, 6,150,322, and 6,153,577.

Suitable for use herein are the ethoxylated alcohols and ethoxylated alkyl phenols of the formula R(OC₂H₄)nOH, wherein R is selected from the group consisting of aliphatic hydrocarbon radicals containing from about 8 to about 20 carbon atoms and alkyl phenyl radicals in which the alkyl groups contain from about 8 to about 12 carbon atoms, and the average value of n is from about 5 to about 15.

Suitable nonionic surfactants are those of the formula R1(OC₂H₄)nOH, wherein R1 is a C₁₀-C₁₆ alkyl group or a C₈-C₁₂ alkyl phenyl group, and n is from 3 to about 80. In one aspect, particularly useful materials are condensation products of C₉-C₁₅ alcohols with from about 5 to about 20 moles of ethylene oxide per mole of alcohol.

Additional suitable nonionic surfactants include polyhydroxy fatty acid amides such as N-methyl N-1-deoxyglucityl cocoamide and N-methyl N-1-deoxyglucityl oleamide and alkyl polysaccharides such as the ones described in U.S. Pat. No. 5,332,528. Alkylpolysaccharides disclosed in U.S. Pat. No. 4,565,647.

The fabric care compositions of the present invention may contain up to about 30%, alternatively from about 0.01% to about 20%, more alternatively from about 0.1% to about 20%, by weight of the composition, of a cationic surfactant. For the purposes of the present invention, cationic surfactants include those which can deliver fabric care benefits. Non-limiting examples of useful cationic surfactants include: fatty amines; quaternary ammonium surfactants; and imidazoline quat materials.

In some embodiments, useful cationic surfactants, include those disclosed in U.S. Patent Application number 2005/0164905 A1 and having the general formula (XIII):

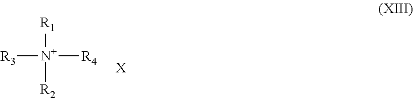

wherein:
(a) R₁ and R₂ each are individually selected from the groups of: C₁-C₄ alkyl; C₁-C₄ hydroxy alkyl; benzyl; —(CnH₂ₙO)ₓH, wherein:
i. x has a value from about 2 to about 5;
ii. n has a value of about 1-4;
(b) R₃ and R₄ are each:
i. a C₈-C₂₂ alkyl; or
ii. R₃ is a C₈-C₂₂ alkyl and R₄ is selected from the group of: C₁-C₁₀ alkyl; C₁-C₁₀ hydroxy alkyl; benzyl; —(CnH₂ₙO)ₓH, wherein:
1. x has a value from 2 to 5; and
2. n has a value of 1-4; and
(c) X is an anion.

Fabric Softening Active Compounds. The fabric softening active may comprise, as the principal active, compounds of the following formula:

{R₄₋ₘ—N⁺—[X—Y—R¹]ₘ}X⁻ (XIV)

wherein each R may comprise either hydrogen, a short chain C₁-C₆, in one aspect a C₁-C₃ alkyl or hydroxyalkyl group, for example methyl, ethyl, propyl, hydroxyethyl, and the like, poly(C₂₋₃ alkoxy), polyethoxy, benzyl, or mixtures thereof; each X may independently be (CH₂)n, CH₂—CH(CH₃)— or CH—(CH₃)—CH₂—; each Y may comprise —O—(O)C—, —C(O)—O—, —NR—C(O)—, or —C(O)—NR—; each m may be 2 or 3; each n may be from 1 to about 4, in one aspect 2; the sum of carbons in each R¹, plus one when Y is —O—(O)C— or —NR—C(O)—, may be C₁₂-C₂₂, or C₁₄-C₂₀, with each R¹ being a hydrocarbyl, or substituted hydrocarbyl group; and X⁻ may comprise any softener-compatible anion. In one aspect, the softener-compatible anion may comprise chloride, bromide, methylsulfate, ethylsulfate, sulfate, and nitrate. In another aspect, the softener-compatible anion may comprise chloride or methyl sulfate.

In another aspect, the fabric softening active may comprise the general formula (XV):

[R₃N⁺CH₂CH(YR¹)(CH₂YR¹)]X⁻ Formula (XV)

wherein each Y, R, R¹, and X⁻ have the same meanings as before. Such compounds include those having the formula (XVI):

[CH₃]₃N⁽⁺⁾[CH₂CH(CH₂O(O)CR¹)O(O)CR¹]C1⁽¹⁾ (XVI)

wherein each R may comprise a methyl or ethyl group. In one aspect, each R¹ may comprise a C₁₅ to C₁₉ group. As used herein, when the diester is specified, it can include the monoester that is present.

These types of agents and general methods of making them are disclosed in U.S. Pat. No. 4,137,180. An example of a suitable DEQA (2) is the “propyl” ester quaternary ammonium fabric softener active comprising the formula 1,2-di(acyloxy)-3-trimethylammoniopropane chloride.

In one aspect, the fabric softening active may comprise the formula (XVII):

[R₄₋ₘ—N⁺—R¹ₘ]X⁻ (XVII)

wherein each R, R¹, m and X⁻ have the same meanings as before.

In a further aspect, the fabric softening active may comprise the formula (XVIII):

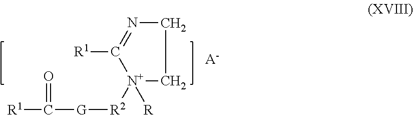

wherein each R and R¹ have the definitions given above; R² may comprise a C₁₋₆ alkylene group, in one aspect an ethylene group; and G may comprise an oxygen atom or an —NR— group; and A⁻ is as defined below.

In a yet further aspect, the fabric softening active may comprise the formula (XIX):

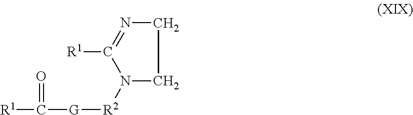

wherein R¹, R² and G are defined as above.

In a further aspect, the fabric softening active may comprise condensation reaction products of fatty acids with dialkylenetriamines in, e.g., a molecular ratio of about 2:1, said reaction products containing compounds of the formula (XX):

R¹—C(O)—NH—R²—NH—R³—NH—C(O)—R¹ (XX)

wherein R¹, R² are defined as above, and R³ may comprise a C₁₋₆ alkylene group, or an ethylene group and wherein the reaction products may optionally be quaternized by the additional of an alkylating agent such as dimethyl sulfate. Such quaternized reaction products are described in additional detail in U.S. Pat. No. 5,296,622.

In a yet further aspect, the fabric softening active may comprise the formula (XXI):

[R¹—C(O)—NR—R²—N(R)₂—R³—NR—C(O)—R¹]⁺A⁻ (XXI)

wherein R, R¹, R² and R³ are defined as above; A⁻ is as defined below;

In a yet further aspect, the fabric softening active may comprise reaction products of fatty acid with hydroxyalkylalkylenediamines in a molecular ratio of about 2:1, said reaction products containing compounds of the formula (XXII):

R¹—C(O)—NH—R²—N(R³OH)—C(O)—R¹ (XXII)

wherein R¹, R² and R³ are defined as above;

In a yet further aspect, the fabric softening active may comprise the formula (XXIII):

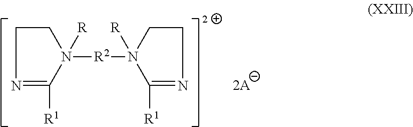

wherein R, R¹ and R² are defined as above; A⁻ is as defined below.

In yet a further aspect, the fabric softening active may comprise the formula (XXIV);

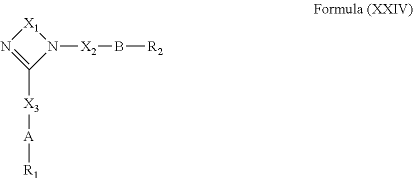

wherein;
X₁ may comprise a C₂₋₃ alkyl group, in one aspect, an ethyl group;
X₂ and X₃ may independently comprise C₁₋₆ linear or branched alkyl or alkenyl groups, in one aspect, methyl, ethyl or isopropyl groups;
R₁ and R₂ may independently comprise C₈₋₂₂ linear or branched alkyl or alkenyl groups;
characterized in that;
A and B are independently selected from the group comprising —O—(C═O)—, —(C═O)—O—, or mixtures thereof, in one aspect, —O—(C═O)—.

Non-limiting examples of fabric softening actives comprising formula (XIV) are N,N-bis(stearoyl-oxy-ethyl)N,N-dimethyl ammonium chloride, N,N-bis(tallowoyl-oxy-ethyl)N,N-dimethyl ammonium chloride, N,N-bis(stearoyl-oxy-ethyl)N-(2 hydroxyethyl)N-methyl ammonium methylsulfate.

A non-limiting example of fabric softening actives comprising formula (XVI) is 1,2di(stearoyl-oxy)3 trimethyl ammoniumpropane chloride.

Non-limiting examples of fabric softening actives comprising formula (XVII) may include dialkylenedimethylammonium salts such as dicanoladimethylammonium chloride, di(hard)tallowedimethylammonium chloride dicanoladimethylammonium methylsulfate. An example of commercially available dialkylenedimethylammonium salts usable in the present invention is dioleyldimethylammonium chloride available from Witco Corporation under the trade name Adogen® 472 and dihardtallow dimethylammonium chloride available from Akzo Nobel Arquad 2HT75.

A non-limiting example of fabric softening actives comprising formula (XVIII) may include 1-methyl-1-stearoylamidoethyl-2-stearoylimidazolinium methylsulfate wherein R¹ is an acyclic aliphatic C₁₅-C₁₇ hydrocarbon group, R² is an ethylene group, G is a NH group, R⁵ is a methyl group and A⁻ is a methyl sulfate anion, available commercially from the Witco Corporation under the trade name Varisoft®.

A non-limiting example of fabric softening actives comprising formula (XIX) is 1-tallowylamidoethyl-2-tallowylimidazoline wherein R¹ may comprise an acyclic aliphatic C₁₅-C₁₇ hydrocarbon group, R² may comprise an ethylene group, and G may comprise a NH group.

A non-limiting example of a fabric softening active comprising formula (XX) is the reaction products of fatty acids with diethylenetriamine in a molecular ratio of about 2:1, said reaction product mixture comprising N,N″-dialkyldiethylenetriamine having the formula (XXV):

R¹—C(O)—NH—CH₂CH₂—NH—CH₂CH₂—NH—C(O)—R¹ Formula (XXV)

wherein R¹ is an alkyl group of a commercially available fatty acid derived from a vegetable or animal source, such as Emersol® 223LL or Emersol® 7021, available from Henkel Corporation, and R² and R³ are divalent ethylene groups.

A non-limiting example of Compound (XXI) is a difatty amidoamine based softener having the formula (XXVI):

[R¹—C(O)—NH—CH₂CH₂—N(CH₃)(CH₂CH₂OH)—CH₂CH₂—NH—C(O)—R¹]⁺CH₃SO₄⁻ Formula (XXVI)

wherein R¹ is an alkyl group. An example of such compound is that commercially available from the Witco Corporation e.g. under the trade name Varisoft® 222LT.

An example of a fabric softening active comprising formula (XXII) is the reaction products of fatty acids with N-2-hydroxyethylethylenediamine in a molecular ratio of about 2:1, said reaction product mixture comprising the formula (XXVII):

R¹—C(O)—NH—CH₂CH₂—N(CH₂CH₂OH)—C(O)—R¹ Formula (XXVII)

wherein R¹—C(O) is an alkyl group of a commercially available fatty acid derived from a vegetable or animal source, such as Emersol® 223LL or Emersol® 7021, available from Henkel Corporation.

An example of a fabric softening active comprising formula (XXIII) is the diquaternary compound having the formula (XXVIII):

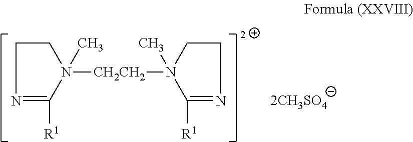

wherein R¹ is derived from fatty acid. Such compound is available from Witco Company.

A non-limiting example of a fabric softening active comprising formula (XXIV) is a dialkyl imidazoline diester compound, where the compound is the reaction product of N-(2-hydroxyethyl)-1,2-ethylenediamine or N-(2-hydroxyisopropyl)-1,2-ethylenediamine with glycolic acid, esterified with fatty acid, where the fatty acid is (hydrogenated) tallow fatty acid, palm fatty acid, hydrogenated palm fatty acid, oleic acid, rapeseed fatty acid, hydrogenated rapeseed fatty acid or a mixture of the above.

It will be understood that combinations of softener actives disclosed above are suitable for use herein.

### Anion A

In the cationic nitrogenous salts herein, the anion A⁻, which comprises any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. In one aspect, the anion A may comprise chloride or methylsulfate. The anion, in some aspects, may carry a double charge. In this aspect, A⁻ represents half a group.

In one aspect, the fabric care and/or treatment composition may comprise a second softening agent selected from the group consisting of polyglycerol esters (PGEs), oily sugar derivatives, and wax emulsions. Suitable PGEs include those disclosed in U.S. PA 61/089,080. Suitable oily sugar derivatives and wax emulsions include those disclosed in USPA 2008-0234165 A1.

In one aspect, the compositions may comprise from about 0.001% to about 0.01% of an unsaturated aldehyde. In one aspect, the compositions are essentially free of an unsaturated aldehyde. Without being limited by theory, in this aspect, the compositions are less prone to the yellowing effect often encountered with amino-containing agents.

Builders—The compositions may also contain from about 0.1% to 80% by weight of a builder. Compositions in liquid form generally contain from about 1% to 10% by weight of the builder component. Compositions in granular form generally contain from about 1% to 50% by weight of the builder component. Detergent builders are well known in the art and can contain, for example, phosphate salts as well as various organic and inorganic nonphosphorus builders. Water-soluble, nonphosphorus organic builders useful herein include the various alkali metal, ammonium and substituted ammonium polyacetates, carboxylates, polycarboxylates and polyhydroxy sulfonates. Examples of polyacetate and polycarboxylate builders are the sodium, potassium, lithium, ammonium and substituted ammonium salts of ethylene diamine tetraacetic acid, nitrilotriacetic acid, oxydisuccinic acid, mellitic acid, benzene polycarboxylic acids, and citric acid. Other suitable polycarboxylates for use herein are the polyacetal carboxylates described in U.S. Pat. No. 4,144,226 and U.S. Pat. No. 4,246,495. Other polycarboxylate builders are the oxydisuccinates and the ether carboxylate builder compositions comprising a combination of tartrate monosuccinate and tartrate disuccinate described in U.S. Pat. No. 4,663,071, Builders for use in liquid detergents are described in U.S. Pat. No. 4,284,532, One suitable builder includes may be citric acid. Suitable nonphosphorus, inorganic builders include the silicates, aluminosilicates, borates and carbonates, such as sodium and potassium carbonate, bicarbonate, sesquicarbonate, tetraborate decahydrate, and silicates having a weight ratio of SiO2 to alkali metal oxide of from about 0.5 to about 4.0, or from about 1.0 to about 2.4. Also useful are aluminosilicates including zeolites. Such materials and their use as detergent builders are more fully discussed in U.S. Pat. No. 4,605,509.

Dispersants—The compositions may contain from about 0.1%, to about 10%, by weight of dispersants Suitable water-soluble organic materials are the homo- or co-polymeric acids or their salts, in which the polycarboxylic acid may contain at least two carboxyl radicals separated from each other by not more than two carbon atoms. The dispersants may also be alkoxylated derivatives of polyamines, and/or quaternized derivatives thereof such as those described in U.S. Pat. Nos. 4,597,898, 4,676,921, 4,891,160, 4,659,802 and 4,661,288.

Enzymes—The compositions may contain one or more detergent enzymes which provide cleaning performance and/or fabric care benefits. Examples of suitable enzymes include hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination may be a cocktail of conventional applicable enzymes like protease, lipase, cutinase and/or cellulase in conjunction with amylase. Enzymes can be used at their art-taught levels, for example at levels recommended by suppliers such as Novozymes and Genencor. Typical levels in the compositions are from about 0.0001% to about 5%. When enzymes are present, they can be used at very low levels, e.g., from about 0.001% or lower; or they can be used in heavier-duty laundry detergent formulations at higher levels, e.g., about 0.1% and higher. In accordance with a preference of some consumers for “non-biological” detergents, the compositions may be either or both enzyme-containing and enzyme-free.

Dye Transfer Inhibiting Agents—The compositions may also include from about 0.0001%, from about 0.01%, from about 0.05% by weight of the compositions to about 10%, about 2%, or even about 1% by weight of the compositions of one or more dye transfer inhibiting agents such as polyvinylpyrrolidone polymers, polyamine N-oxide polymers, copolymers of N-vinylpyrrolidone and N-vinylimidazole, polyvinyloxazolidones and polyvinylimidazoles or mixtures thereof.

Chelant—The compositions may contain less than about 5%, or from about 0.01% to about 3% of a chelant such as citrates; nitrogen-containing, P-free aminocarboxylates such as EDDS, EDTA and DTPA; aminophosphonates such as diethylenetriamine pentamethylenephosphonic acid and, ethylenediamine tetramethylenephosphonic acid; nitrogen-free phosphonates e.g., HEDP; and nitrogen or oxygen containing, P-free carboxylate-free chelants such as compounds of the general class of certain macrocyclic N-ligands such as those known for use in bleach catalyst systems.

Brighteners—The compositions may also comprise a brightener (also referred to as “optical brightener”) and may include any compound that exhibits fluorescence, including compounds that absorb UV light and reemit as “blue” visible light. Non-limiting examples of useful brighteners include: derivatives of stilbene or 4,4′-diaminostilbene, biphenyl, five-membered heterocycles such as triazoles, pyrazolines, oxazoles, imidiazoles, etc., or six-membered heterocycles (coumarins, naphthalamide, s-triazine, etc.). Cationic, anionic, nonionic, amphoteric and zwitterionic brighteners can be used. Suitable brighteners include those commercially marketed under the trade name Tinopal-UNPA-GX® by Ciba Specialty Chemicals Corporation (High Point, N.C.).

Bleach system—Bleach systems suitable for use herein contain one or more bleaching agents. Non-limiting examples of suitable bleaching agents include catalytic metal complexes; activated peroxygen sources; bleach activators; bleach boosters; photobleaches; bleaching enzymes; free radical initiators; H₂O₂; hypohalite bleaches; peroxygen sources, including perborate and/or percarbonate and combinations thereof. Suitable bleach activators include perhydrolyzable esters and perhydrolyzable imides such as, tetraacetyl ethylene diamine, octanoylcaprolactam, benzoyloxybenzenesulphonate, nonanoyloxybenzene-isulphonate, benzoylvalerolactam, dodecanoyloxybenzenesulphonate. Suitable bleach boosters include those described in U.S. Pat. No. 5,817,614. Other bleaching agents include metal complexes of transitional metals with ligands of defined stability constants. Such catalysts are disclosed in U.S. Pat. Nos. 4,430,243, 5,576,282, 5,597,936 and 5,595,967.

Stabilizer—The compositions may contain one or more stabilizers and thickeners. Any suitable level of stabilizer may be of use; exemplary levels include from about 0.01% to about 20%, from about 0.1% to about 10%, or from about 0.1% to about 3% by weight of the composition. Non-limiting examples of stabilizers suitable for use herein include crystalline, hydroxyl-containing stabilizing agents, trihydroxystearin, hydrogenated oil, or a variation thereof, and combinations thereof. In some aspects, the crystalline, hydroxyl-containing stabilizing agents may be waterinsoluble wax-like substances, including fatty acid, fatty ester or fatty soap. In other aspects, the crystalline, hydroxyl-containing stabilizing agents may be derivatives of castor oil, such as hydrogenated castor oil derivatives, for example, castor wax. The hydroxyl containing stabilizers are disclosed in U.S. Pat. Nos. 6,855,680 and 7,294,611. Other stabilizers include thickening stabilizers such as gums and other similar polysaccharides, for example gellan gum, carrageenan gum, and other known types of thickeners and rheological additives. Exemplary stabilizers in this class include gum-type polymers (e.g. xanthan gum), polyvinyl alcohol and derivatives thereof, cellulose and derivatives thereof including cellulose ethers and cellulose esters and tamarind gum (for example, comprising xyloglucan polymers), guar gum, locust bean gum (in some aspects comprising galactomannan polymers), and other industrial gums and polymers.

For the purposes of the present invention, the non-limiting list of adjuncts illustrated hereinafter are suitable for use in the instant compositions and may be desirably incorporated in certain embodiments of the invention, for example to assist or enhance performance, for treatment of the substrate to be cleaned, or to modify the aesthetics of the composition as is the case with perfumes, colorants, dyes or the like. It is understood that such adjuncts are in addition to the components that are supplied via Applicants' perfumes and/or perfume systems. The precise nature of these additional components, and levels of incorporation thereof, will depend on the physical form of the composition and the nature of the operation for which it is to be used. Suitable adjunct materials include, but are not limited to, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, processing aids and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

Silicones—Suitable silicones comprise Si—O moieties and may be selected from (a) non-functionalized siloxane polymers, (b) functionalized siloxane polymers, and combinations thereof. The molecular weight of the organosilicone is usually indicated by the reference to the viscosity of the material. In one aspect, the organosilicones may comprise a viscosity of from about 10 to about 2,000,000 centistokes at 25° C. In another aspect, suitable organosilicones may have a viscosity of from about 10 to about 800,000 centistokes at 25° C. Suitable organosilicones may be linear, branched or cross-linked. In one aspect, the organosilicones may be linear.

The present invention will be disclosed further by the following non-limiting examples:

### EXAMPLES

“Low concentrated emulsions” shall mean emulsions where the water content lies above 40 weight %, preferably in the range of from 45 weight % to 65 weight %, based on the total weight of the emulsion.

“Highly concentrated emulsions” shall mean emulsions where the water content lies below or is equal to 40 weight %, preferably in the range from 20 weight % to 35 weight %, based on the total weight of the emulsion.

The cleaning and/or treatment compositions of the present invention can be formulated into any suitable form and prepared by any process chosen by the formulator, non-limiting examples of which are described in U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; U.S. Pat. No. 5,486,303 all of which are incorporated herein by reference.

### Analytical Methods:

### K-Value

The K value of the polymers of the invention was determined in accordance with Fikentscher (see H. Fikentscher, Cellulosechemie 13 (1932), 58-64 and 71-74) by measuring the viscosity of 0.1% strength by weight solutions of the polymers in 3% strength by weight NaCl solution.

### Solids Content

The solid content was determined by drying the aqueous solution of the polymer in an oven at 100° C., for 2 h, at reduced pressure (100 mbar).

### Examples P1 to P12

### Synthesis of the Polymeric Cationic Emulsifier Pₓ

### Example P1

In a 2 L stirred vessel, water (38 g) and isopropanol (230 g) were charged and heated to 80° C. under a flow of nitrogen. A solution of laurylacrylate (71 g) in isopropanol (230 g) as well as a 65% aqueous solution of diallyldimethylammoniumchloride (366 g) and acrylic acid (21 g) are added each in separate feeds over 4 h at 80° C. At the same time, a solution of 2,2′-azobis(2-methylpropionamidine)dihydrochloride (3.3 g, supplied by Wako Specialty Chemicals) in water (44 g) is added over 4.25 h. The polymerization mixture is kept at this temperature for an additional 1 h. The isopropanol was removed by distillation and water (506 g) was added to yield a 36% solution of terpolymer P1.

### Example P3

In a 2 L stirred vessel, water (31 g) and isopropanol (230 g) were charged and heated to 80° C. under a flow of nitrogen. A solution of laurylacrylate (75 g) in isopropanol (230 g), and a 65% aqueous solution of diallydimethylammoniumchloride (388 g) were added in separate feeds over 4 h at 80° C. At the same time, a solution of sodiumperoxodisulfate (3.3 g) in water (43 g) is added over 4.25 h. The polymerization mixture is kept at this temperature for an additional 1 h. The isopropanol was removed by distillation and water (498 g) was added to yield a 38% solution of the copolymer P3.

### Example P11

In a 2 L stirred vessel, water (33 g) and isopropanol (195 g) were charged and heated to 80° C. under a flow of nitrogen. A solution of laurylacrylate (75 g) in isopropanol (194 g) and 65% aqueous solution of diallydimethylammoniumchloride (310 g) were added in separate feeds over 4 h at 80° C. At the same time, a solution of 2,2′-azobis(2-methylpropionamidine)dihydrochloride (2.8 g, supplied by Wako Specialty Chemicals) in water (37 g) are added over 4.25 h. The polymerization mixture is kept at this temperature for an additional 1 h. The isopropanol was removed by distillation and water (390 g) was added. This yielded a 37% solution of copolymer P11.

### Further Polymerization Examples

Polymers P6-P10 as well as Comparative Polymers CP1 and CP2 were prepared in a similar way as described in Example P1, taking the monomers and the respective amounts given in Table 1.

Polymers P2, P4, P5 and P12 were prepared in a similar way as described in Example P11, taking the monomers and the respective amounts given in Table 1.

TABLE 1

| | | | | | | | | | Precharge | Precharge | Solids Con- | |
|---|---|---|---|---|---|---|---|---|---|---|---|---|
| | DADMAC | LA | AA | DADMAC | LA | AA | Isopropanol | Init. | water | Isopropanol | [symbol] | |
| Ex.: | [wt.-%] | [wt.-%] | [wt.-%] | [g] | [g] | [g] | [g] | [g] | [g] | [g] | [wt.-%] | K-Value |
| P1 | 71.40 | 14.30 | 14.30 | 366.2 | 70.9 | 21.3 | 220 | 3.30 | 43.9 | 223.0 | 36.1 | 16 |
| P2 | 90.00 | 10.00 | 0.00 | 462.1 | 49.6 | 0.0 | 152 | 3.50 | 18.8 | 325.9 | 40.2 | 15 |
| P3 | 83.30 | 16.60 | 0.00 | 387.3 | 75.0 | 0.0 | 230 | 3.27 | 31.2 | 229.9 | 35.0 | 21 |
| P4 | 82.50 | 17.50 | 0.00 | 444.4 | 91.1 | 0.0 | 388 | 3.80 | 36.2 | 141.5 | 35.0 | 14 |
| P5 | 75.00 | 25.00 | 0.00 | 411.4 | 132.6 | 0.0 | 432 | 4.00 | 57.8 | 125.6 | 36.8 | 11 |
| P6 | 70.00 | 25.00 | 5.00 | 393.7 | 135.9 | 8.2 | 442 | 4.00 | 64.0 | 114.6 | 38.5 | 13 |
| P7 | 76.25 | 17.50 | 6.25 | 436.2 | 96.8 | 10.4 | 315 | 3.91 | 64.8 | 226.8 | 38.2 | 12 |
| P8 | 80.00 | 10.00 | 10.00 | 483.2 | 58.4 | 17.5 | 190 | 3.90 | 27.11 | 352.0 | 37.5 | 14 |
| P9 | 70.00 | 17.50 | 12.50 | 434.5 | 105.2 | 22.5 | 343 | 4.10 | 77.6 | 226.5 | 38.7 | 12 |
| P10 | 70.00 | 10.00 | 20.00 | 417.9 | 57.7 | 34.6 | 188 | 3.65 | 37.27 | 318.9 | 40.1 | n.d. |
| P11 | 80.00 | 20.00 | 0.00 | 310.4 | 75.1 | 0.0 | 195 | 2.77 | 32.9 | 194.7 | 37.0 | 16 |
| P12 | 66.67 | 33.33 | 0.00 | 288.1 | 139.5 | 0.0 | 230 | 3.27 | 66.1 | 229.8 | 36.6 | 12 |
| CP1 | 73.30 | 0.00 | 26.70 | 136.65 | 0.0 | 32.4 | 0.0 | 0.6 | 352.9 | 0.0 | 22.8 | 12 |
| CP2 | 54.70 | 0.00 | 45.30 | 261.15 | 0.0 | 140.5 | 0.0 | 0.05 | 337.43 | 0.0 | 41.6 | 67.8 |

[symbol]

indicates data missing or illegible when filed

### Examples LC1 to LC12

### Preparation of Low Concentrated Emulsions

### Example LC1

Polyisobutene (PIB) (molecular weight 1000 g/mol) (17.5 parts per weight) and paraffin oil (17.5 parts per weight) were mixed and the mixture heated to 80° C. Polymer P1 (1.75 parts per weight, calculated as active content) and nonionic surfactant C10-Guerbet alcohol alkoxylate (HLB 12.5, 8.8 parts per weight) were mixed with de-ionized water (54.4 parts per weight) and heated to 80° C. as well.

The PIB/paraffin mixture was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. A homogeneous emulsion that is stable against phase-separation for >1 week is formed.

### Example LC2-LC12

The following examples were prepared in a similar way as described in Example LC1, using the same quantities of the respective polymers P2-P12. The stability results are given in Table 2. Emulsion stability is assessed by visual inspection after 2 h, 3 days and 6 days, and an average is calculated. All emulsions were homogeneous and did not show phase separation. Some emulsions showed creaming after 3 d or 6 d. The degree of creaming is assessed and graded by visual inspection, with grade 1 being a perfectly homogeneous emulsion showing not signs of creaming, and grade 6 being an emulsion that is completely creamed. Nevertheless, all emulsions were stable against phase separation and a homogeneous emulsion could easily be reformed by shaking or stirring with a low shear magnetic stirrer.

TABLE 1

| Example | Polymer: | 2 h | 3 d | 6 d | Average |
|---|---|---|---|---|---|
| LC1 | P1 | 1.0 | 1.0 | 1.0 | 1.0 |
| LC2 | P2 | 1.0 | 1.0 | 3.0 | 1.7 |
| LC3 | P3 | 1.0 | 1.0 | 1.0 | 1.0 |
| LC4 | P4 | 3.0 | 3.0 | 3.0 | 3.0 |
| LC5 | P5 | 6.0 | 3.0 | 6.0 | 5.0 |
| LC6 | P6 | 6.0 | 6.0 | 6.0 | 6.0 |
| LC7 | P7 | 1.0 | 1.0 | 3.0 | 1.7 |
| LC8 | P8 | 1.0 | 1.0 | 3.0 | 1.7 |
| LC9 | P9 | 1.0 | 3.0 | 3.0 | 2.3 |
| LC10 | P10 | 1.0 | 1.0 | 3.0 | 1.7 |

### Examples HC1 to HC12

### Preparation of Highly Concentrated Emulsions

### Example HC1

Polyisobutene (PIB) (molecular weight 1000 g/mol) (10.0 g, 41.6 parts per weight) was heated to 80° C.

Polymer P1 (4.25 g calculated as solid polymer, 41.6 parts per weight) and nonionic surfactant C10-Guerbet alcohol alkoxylate (HLB 12.5) (2.55 g, 10.4 parts per weight) were mixed and heated to 80° C. as well. The residual water originates from the water content of the raw materials. The PIB was placed in a heated beaker and fitted with a high shear mixer (Polytron PT 10-35 GT) and the speed was set to 8000 to 10000 rpm. At 80° C. the mixture of polymer and non-ionic surfactant was added and treated at this shear rate for 120 sec without further heating. A homogeneous, highly concentrated emulsion that is stable against phase-separation for >2 week is formed.

### Examples HC2-HC12

The following examples were prepared in a similar way as described in Example HC1, taking the polymers and the respective amounts given in Table 3. All emulsions HC1-HC12 can be diluted with water by simple low-shear stirring with a magnetic stirrer bar. Emulsion stability is assessed by visual inspection after 4 h and 14 days. Emulsions are graded “homogeneous” (H in Table 3) when no visually observable creaming/sedimentation and no coalescence and phase separation can be observed; they are graded “creaming” when creaming (CR) was observed but a homogeneous emulsion could be reformed by low-shear stifling. Emulsions were graded “phase separation” (PS) when an oily phase was reformed and the emulsion could not easily be simple low-shear stifling.

TABLE 2

| | | | Polymer | | | | |
|---|---|---|---|---|---|---|---|
| | | | (calculated | Nonionic | Residual | Emulsion | Emulsion |
| | | Polyisobutene | as active) | Surfactant | Water | Stability | Stability |
| Example | Polymer: | [wt.-%] | [wt.-%] | [wt.-%] | [wt.-%] | (4 h) | (14 days) |
| HC1 | P1 | 41.6 | 17.3 | 10.4 | 30.7 | H | H |
| HC2 | P2 | 43.7 | 18.2 | 10.9 | 27.1 | H | CR |
| HC3 | P3 | 41.0 | 17.1 | 10.2 | 31.7 | H | CR |
| HC4 | P4 | 44.2 | 18.4 | 11.0 | 26.4 | H | CR |
| HC5 | P5 | 42.0 | 17.5 | 10.5 | 30.0 | H | H |
| HC6 | P6 | 42.9 | 17.9 | 10.7 | 28.5 | H | PS |
| HC7 | P7 | 42.7 | 17.8 | 10.7 | 28.8 | H | PS |
| HC8 | P8 | 42.4 | 17.6 | 10.6 | 29.4 | H | CR |
| HC9 | P9 | 43.0 | 17.9 | 10.7 | 28.4 | H | PS |
| HC10 | P10 | 43.7 | 18.2 | 10.9 | 27.2 | H | CR |
| HC11 | P11 | 41.6 | 17.7 | 10.6 | 30.1 | H | H |
| HC12 | P12 | 41.4 | 17.6 | 10.6 | 30.5 | H | PS |

H = Homogeneous,
CR = Creaming,
PS = Phase separation.

### Comparative Examples

### Comparative Example HC11

Polyisobutene (PIB) (molecular weight 1000 g/mol) (17.5 parts per weight) and paraffin oil (17.5 parts per weight) were mixed and the mixture heated to 80° C.

The copolymer of DADMAC and acrylic acid CP1 (1.75 parts per weight, calculated as active content) and nonionic surfactant C10-Guerbet alcohol alkoxylate (HLB 12.5, 8.8 parts per weight) were mixed with de-ionized water (54.4 parts per weight) and heated to 80° C. as well.

The PIB/paraffin mixture was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. The resulting mixture showed creaming immediately after emulsification and was separated into a clear water phase below and a white highly viscous phase on top. After stifling, creaming reappeared immediately.

### Comparative Example HC12

Polyisobutene (PIB) (molecular weight 1000 g/mol) (17.5 parts per weight) and paraffin oil (17.5 parts per weight) were mixed and the mixture heated to 80° C.

The copolymer of DADMAC and acrylic acid CP2 (1.75 parts per weight, calculated as active content) and nonionic surfactant C10-Guerbet alcohol alkoxylate (HLB 12.5, 8.8 parts per weight) were mixed with de-ionized water (54.4 parts per weight) and heated to 80° C. as well.

The PIB/paraffin mixture was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. The resulting mixture showed creaming after approx. 4 hours and was separated into a clear water phase below and a white highly viscous phase on top. After stifling, creaming reappeared immediately.

### Comparative Example HC13

Polyisobutene (PIB) (molecular weight 1000 g/mol) (17.5 parts per weight) and paraffin oil (17.5 parts per weight) were mixed and the mixture heated to 80° C.

The DADMAC homopolymer CP3 (commercial Poly-DADMAC sample, (as supplied for example by Sigma-Aldrich under order numbers 522376 or 409014, CAS-#26062-79-3) (1.75 parts per weight, calculated as active content) and nonionic surfactant C10-Guerbet alcohol alkoxylate (HLB 12.5, 8.8 parts per weight) were mixed with de-ionized water (54.4 parts per weight) and heated to 80° C. as well.

The PIB/paraffin mixture was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. The resulting mixture showed creaming immediately after emulsification and was separated into a clear water phase below and a white highly viscous phase on top. After stifling, creaming reappeared immediately.

### Further Emulsification Experiments:

### Experiment A:

Paraffin (35.0 parts per weight) was heated to 80° C. Polymer P1 (5 parts per weight, calculated as active content) and nonionic surfactant C10-Guerbet alcohol alkoxylate (HLB 12.5, 8.8 parts per weight) were mixed with de-ionized water (51.2 parts per weight) and heated to 80° C. as well.

The Paraffin was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. A homogeneous paraffin emulsion that is stable against phase-separation for >2 week is formed.

### Experiment B:

Corn oil (35.0 parts per weight) was heated to 80° C. Polymer P1 (5 parts per weight, calculated as active content) and nonionic surfactant C10-Guerbet alcohol alkoxylate (HLB 12.5, 8.8 parts per weight) were mixed with de-ionized water (51.2 parts per weight) and heated to 80° C. as well.

The corn oil was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. A homogeneous paraffin emulsion that is stable against phase-separation for >2 week is formed.

### Experiment C:

Soy bean oil (35.0 parts per weight) was heated to 80° C. Polymer P1 (5 parts per weight, calculated as active content) and nonionic surfactant C10-Guerbet alcohol alkoxylate (HLB 12.5, 8.8 parts per weight) were mixed with de-ionized water (51.2 parts per weight) and heated to 80° C. as well.

The soy bean oil was placed in a heated beaker and fitted with the Ultraturrax equipped with shear-head T50 and the speed was set to 5000 to 6000 rpm. At 80° C. the mixture of water, polymer and non-ionic surfactant was added and emulsified for 120 sec without further heating. A homogeneous paraffin emulsion that is stable against phase-separation for >2 week is formed.

The following example formulations are made containing the emulsions of the present invention:

### Preparation of a Standard Liquid Detergent Formulation (A):

Liquid detergent fabric care compositions of Example A are made by mixing together the ingredients listed in the proportions shown;

| Ingredient (wt %) | A |
|---|---|
| C₁₂-C₁₅ alkyl polyethoxylate (1.8) sulfate¹ | 20.1 |
| C₁₂ alkyl trimethyl ammonium chloride⁴ | 2.0 |
| C₁₂-C₁₄ alcohol 9 ethoxylate³ | 0.8 |
| Monoethanolamine | 2.5 |
| Na cumenesulfonate | 1.8 |
| C₁₂-C₁₈ Fatty Acid⁵ | 1.0 |
| Citric acid⁶ | 3.4 |
| Protease⁷ (52 g/L) | 0.35 |
| Fluorescent Whitening Agent⁸ | 0.08 |
| Diethylenetriamine pentaacetic acid⁶ | 0.5 |
| Ethoxylated polyamine⁹ | 0.6 |
| PIB emulsion from examples P1-P12, CP1-CP2, | 0.01-20.0 |
| LC1-LC12, and/or HC1-HC12 | |
| Water, perfumes, dyes, buffers, solvents and | to 100% |
| other optional components | pH 8.0-8.2 |

¹Available from Shell Chemicals, Houston, TX.
²Available from Sasol Chemicals, Johannesburg, South Africa
⁴Available from Evonik Corporation, Hopewell, VA.
⁵Available from The Procter & Gamble Company, Cincinnati, OH.
⁶Available from Sigma Aldrich chemicals, Milwaukee, WI
⁷Available from Genencor International, South San Francisco, CA.
⁸Available from Ciba Specialty Chemicals, High Point, NC
⁹600 g/mol molecular weight polyethylenimine core with 20 ethoxylate groups per —NH and available from BASF (Ludwigshafen, Germany)

### Preparation of a Standard Liquid Fabric Enhancer Formulation (B):

Rinse-Added fabric care compositions are prepared by mixing together ingredients shown below:

| Ingredient | B |
|---|---|
| Fabric Softener Active¹ | 11.0 |
| PIB emulsion from examples P1-P12, CP1-CP2, | 0.01-20.0 |
| LC1-LC12, and/or HC1-HC12 | |
| Lutensol XL-70² | 1.0 |
| Quaternized polyacrylamide⁴ | 0.25 |
| Calcium chloride³ | 0.15 |
| Ammonium chloride³ | 0.1 |
| Alkyl siloxane polymer⁶ | 1.5 |
| Perfume | 1.75 |
| Perfume microcapsule⁵ | 0.69 |
| Water, suds suppressor, stabilizers, pH control | to 100% |
| agents, buffers, dyes & other optional ingredients | pH = 3.0 |

¹N,N-di(tallowoyloxyethyl)-N,N dimethylammonium chloride available from Evonik Corporation, Hopewell, VA.
²Available from BASF (Ludwigshafen, Germany)
³Available from Sigma Aldrich chemicals, Milwaukee, WI
⁴Cationic polyacrylamide polymer such as a copolymer of acrylamide/[2-(acryloylamino)ethyl]tri-methylammonium chloride (quaternized dimethyl aminoethyl acrylate) available from BASF, AG, Ludwigshafen under the trade name Sedipur ® 544.
⁵Available from Appleton Paper of Appleton, WI
⁶Aminofunctional silicone available from Shin-Etsu Silicones, Akron, OH

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising an emulsion comprising:
a) oil(s) in an amount of from 2 to 75 weight %,
b) polymeric cationic emulsifiers Pₓ in an amount of from 0.05 to 40 weight %, wherein Pₓ is the product of the polymerization of
A) one or more cationic ethylenically unsaturated monomers (monomer A),
B) one or more linear or branched alkyl(meth)acrylates (monomer B),
C) from 0 to 30 weight % of one or more C₃-C₈ monoethylenically unsaturated carboxylic acids (monomer C),
c) surfactant(s) Sₓ in an amount of from 0 to 25 weight %,
d) additive(s) Aₓ in an amount of from 0 to 20 weight % and
e) water in an amount of from 10 to 97.95 weight %,
based on the total weight of the emulsion
said composition being a fabric and/or home care composition, said composition containing a fabric and/or home care ingredient.

2. The composition according to claim 1, wherein the components of the emulsion independently of each other are present in amounts of:
a) oil(s) in an amount of from 5 to 50 weight %,
b) polymeric cationic emulsifiers Pₓ in an amount of from 0.5 to 30 weight %, wherein Pₓ is the product of the polymerization of
A) one or more monomers A,
B) one or more monomers B,
C) from 0 to 30 weight % of one or monomers C,
c) surfactant(s) Sₓ in an amount of from 0.1 to 20 weight %,
d) additive(s) Aₓ in an amount of from 0.1 to 15 weight % and
e) water in an amount of from 30 to 90 weight %,
based on the total weight of the emulsion.

3. The composition according to claim 1, wherein the components of the emulsion independently of each other are present in amounts of:
a) oil(s) in an amount of from 10 to 40 weight %,
b) polymeric cationic emulsifiers Pₓ in an amount of from 0.5 to 15 weight %, wherein Pₓ is the product of the polymerization of
A) one or more monomers A,
B) one or more monomers B,
C) from 0 to 30 weight % of one or more monomers C,
c) surfactant(s) Sₓ in an amount of from 0.1 to 15 weight %,
d) additive(s) Aₓ in an amount of from 1 to 10 weight % and
e) water in an amount of from 40 to 85 weight %,
based on the total weight of the emulsion.

4. The composition according to claim 3, wherein the components of the emulsion independently of each other are present in amounts of:
a) oil(s) in an amount of from 15 to 30 weight %,
b) polymeric cationic emulsifiers Pₓ in an amount of from 0.5 to 5 weight %, wherein Pₓ is the product of the polymerization of
A) one or more monomers A,
B) one or more monomers B,
C) from 0 to 30 weight % of one or more monomers C,
c) surfactant(s) Sₓ in an amount of from 0.5 to 10 weight %,
d) additive(s) Aₓ in an amount of from 2 to 8 weight % ad
e) water in an amount of from 50 to 80 weight %,
based on the total weight of the emulsion.

5. The composition according to claim 4, wherein the oil(s) of the emulsion is/are selected from the group consisting of:
a1) polyolefines,
a2) silicone oils,
a3) natural oil(s),
a4) mineral oils, having a boiling point at atmospheric pressure of 150° C. or higher,
a5) esters of C₁₋₁₀- to C₂₋₆-carboxylic acid with C₈-C₂₄-alcohols,
and/or mixtures thereof.

6. The composition according to claim 5, wherein the oil(s) of the emulsion is/are selected from the group consisting of: polyethylene, polypropylene, polybutylene and polyisobutene.

7. The composition according to claim 6, wherein the polymeric cationic emulsifier Pₓ of the emulsion is the product of the polymerization of
A) from 60 to 95 weight % of monomer A,
B) from 5 to 45 weight % of monomer B
C) from 0 to 30 weight % of monomer C.

8. The composition according to claim 7, wherein the polymeric cationic emulsifier Pₓ of the emulsion is the product of the polymerization of
A) diallyl dimethyl ammonium chloride,
B) one or more linear or branched C₁₂-C₂₀ alkyl(meth)acrylates,
C) from 0 to 30 weight % of acrylic acid.

9. The composition according to claim 7, wherein the polymeric cationic emulsifier Pₓ of the emulsion is the product of the polymerization of
A) diallyl dimethyl ammonium chloride,
B) lauryl acrylate,
C) from 0 to 30 weight % of acrylic acid.

10. The composition according to claim 9, wherein the surfactant(s) Sₓ of the emulsion is/are selected from the group consisting of:
c1) nonionic surfactants,
c2) anionic surfactants and
c3) cationic surfactants.

11. The composition according to claim 10, wherein the emulsion has a content of organic solvent below 50 mg/kg of emulsion.

12. A method of treating and/or cleaning a situs, said method comprising
a.) optionally washing and/or rinsing said situs;
b.) contacting said situs with a composition according to any one of claims 1-11; and
c.) optionally washing and/or rinsing said situs.
